(19) United States
(12) Patent Application Publication
(10) Pub. No.: US 2003/0002933 A1
(43) Pub. Date: Jan. 2, 2003

(54) Rotary shaft tool and process for machining bores with such a shaft tool

(76) Inventor: Gerhard Schanz, Burladingen-Melchingen (DE)

Correspondence Address: M. Robert Kestenbaum, 11011 Bermuda Dunes NE, Albuquerque, NM, 87111, US

(21) Appl. No.: 10/190,178

(22) Filed: Jul. 5, 2002

Related U.S. Application Data
(63) Continuation-in-part of application No. 09/095,846, filed on Jun. 11, 1998, now abandoned.

(30) Foreign Application Priority Data
Jun. 12, 1997 (DE) 197 24 855.1

(51) Int. Cl. B23B 51/00

(52) U.S. Cl. 408/1 R; 408/227

(57) ABSTRACT

A process and a tool for high performance fine machining of boreholes employs a rotary tool with a shaft with at least one longitudinal channel for coolant and lubricant and a cutting head with at least one cutting edge and a chip groove, wherein a back rake (γ) of a minor cutting edge of less than 0° is used. The relationship of the back rake (γ) to the cutting edge (κ) of the tool is such that the smaller the back rake angle (γ), the larger the cutting edge angle (κ).

### CROSS-REFERENCES TO RELATED APPLICATIONS

Not applicable.

Statement Regarding Federally Sponsored Research or Development

Not applicable.

### BACKGROUND OF THE INVENTION

The invention relates to a process for machining bores with a rotary shaft tool and a rotary shaft tool for performing the process.

### TECHNICAL FIELD

Rotary shaft tools have already become known for the machining of bores, and in particular for fine machining or high performance fine machining; they are constructed as reamers. The reamers have a shaft in which there extends at least one longitudinal channel for coolant/lubricant. The shaft is connected to a cutting head that has at least one chip groove and a groove outlet region. Such reamers for fine machining are known, for example, from German Standard DIN 2172, Part 1. Various parameters for cutter geometry include, for example, the chamfer length, the orthogonal rake angle, the cutting edge angle, the back rake, the minor cutting edge angle, the side rake, or the like. For example, for a machine reamer, a cutting edge angle κ equal to 45° is given. For hand reamers, the cutting edge angle κ is equal to 20°−30°. Thus cutting edge angles κ of between 0° and 45° are given for DIN tools. The back rake γ is in a region between 0° and 15°, according to the type of tool.

Such rotary shaft tools have the disadvantage that during chip formation they form very long structures that come out as strips, such as, for example, flowing chips or ribbon chips, or helical chips, snarl chips or spiral chips. These chips become even further enlarged at very high cutting speeds, as is the case for the use of such shaft tools that are used in particular in conveyor lines, for example, in three-shift operation in automatic production. In the machining of blind holes, these long, strip-shaped chips are taken out of the blind hole in the direction of the shaft of the shaft tool. They lie and are wound around the shaft of the shaft tool. In the first place, the chips cannot be taken away fast enough, so that the chip remains in the bore for too long, and a damaged envelope surface of the bore can result. In addition to this, an introduction of the shaft tool into the next hole to be machined is made difficult, or stopping of the drill can be caused.

### SUMMARY OF THE INVENTION

The object of the invention is to provide a process for machining boreholes with shaft tools, in which a chip can be produced that breaks off short, and makes a rapid and secure chip removal from the borehole possible. This object is achieved by a process for high performance fine machining of boreholes employing a rotary tool having a shaft with at least one longitudinal channel for coolant and lubricant and a cutting head that has at least one cutting edge, a chip groove and a minor cutting edge with a back rake (γ) of less than 0°, and machining a borehole with a feed per revolution and per cutting edge of the shaft tool that depends on the difference between the diameter of the borehole and the rotary shaft cutting tool.

A further object of the invention is to provide a rotary shaft tool that, based on the setting parameters of the major cutting edge and/or the minor cutting edge, makes possible a chip that breaks off short, particularly at given operating parameters. This object is achieved by a rotary shaft tool having a shaft with at least one longitudinal channel for coolant and lubricant, a cutter head joined to the shaft having at least one cutting edge at an angle (κ) with respect to a longitudinal axis of the tool shaft, a minor cutting edge having a back rake (γ) and a chip groove, in which the back rake (γ) is between about less than 0° and about −20°, and the relationship of the back rake (γ) to the cutting edge angle (κ) of the rotary shaft tool is such that the smaller the negative back rake (γ) the larger the cutting edge angle (κ).

The process according to the invention has the advantage that by using the rotary shaft tool with a back rake having a minor cutting edge of less than 0°, and a feed speed that substantially depends on the dimensions of the borehole to be machined, a short-breaking chip can be produced that in particular can be easily and quickly brought out of the blind hole. This short-breaking chip is produced by relating the cutting edge angle to the back rake, where a negative back rake makes possible a dragging cut and the chip is deflected to a large extent at the tool face. A higher fracture deformation can thereby be obtained. Furthermore, the short-breaking chip enables the machining parameters, in particular the feed, to be set so that a chip is formed that has a cross section that ranges from rectangular to square, preferably nearly square.

The deformation behavior for these very short-breaking chips is based on the following principles. In the known long and strip-shaped chips, the cross section of the chips has a very much greater chip width than the thickness of the chip. Consequently, the heat energy that arises during cutting can be fully taken up by the chip. The very thin structure of the chip makes it possible for the extension or the ductility of the chip, or its deformation behavior, to be substantially increased, and therefore no breaking of the chip can be attained. The invention, on the contrary, is based on the fact that the heat energy arising during cutting cannot be fully taken up in the substantially square cross section of the chip. Furthermore, a strong fracture deformation of the chip is produced because of the negative back rake, and is favored by the smaller uptake of heat energy. A very short-breaking chip can be produced in this manner.

The feed per revolution and per cutting edge increases with the dimension of the borehole. The feed per revolution and per cutting edge depends on the dimensions of the borehole to be machined, so that the ratios between the dimensions of the borehole and the feed are substantially equal, and preferably do not exceed a deviation of ±50%.

By means of the process according to the invention, a defined, short-breaking chip formation can be attained that is transformed during the machining operation into a defined chip removal. This is of particular advantage at very high cutting speeds, in that the processing or operating safety is increased. The process can preferably be used in automatic production, for example, three-shift operation, or on conveyor lines, and the like.

The process for producing a rectangular to square cross section of a chip is particularly advantageous with a feed per cutting edge and per revolution of the shaft tool that relates to the dimension of the borehole to be machined. The cutting edge angle κ of a major cutting edge is advantageously made greater than 45°, preferably between 45° and 90°. For example, with a cutting edge angle of κ equal to 90°, a nearly square cross section is attained.

The tool according to the invention has the advantage that the size of the cutting edge angle of the major cutting edge and of the back rake of the minor cutting edge make possible an even shorter chip break. For example, with a cutting edge angle κ in the boundary region of 90°, the back rake γ is made less than −5° and can, for example, decrease as far as 0° in this region. This is based on the fact that with a very large cutting edge angle κ a relatively thick chip can be attained that has only a small deformability and breaks at a very small negative back rake. At the same time, a higher tool life and higher machining parameters, with maintained quality of the borehole, is made possible by thus making the back rake small.

With a cutting edge angle κ in a range between 45° and 55°, the back rake γ is made larger, that is, between −5° and −15°, for example. The chip produced with these parameters has a preferably rectangular cross section, approximating a square cross section. Since the deformation behavior of this cross section is slightly larger than that of a square cross section, a very short-breaking chip can be produced by making the back rake γ larger.

As long as the cutting edge angle κ is made smaller than, for example, 45°, the back rake γ can be made more negative. The relationship between the cutting edge angle and the back rake is such that the angle of the cutting edge increases as the negative back rake decreases.

According to an advantageous embodiment of the shaft tool according to the invention, making the cutting edge angle κ greater than 45° and the back rake of the minor cutting edge less than 0°, a short-breaking chip is made possible with the use of the shaft tool as, in particular, a high performance reamer for fine machining of blind holes. In contrast to the parameters established by DIN 2172, Part 1, it has surprisingly been found that by making the cutting edge angle in fact greater than 45° by making the back rake negative, a particularly short-breaking chip can be produced.

### BRIEF DESCRIPTION OF THE DRAWINGS

The invention will now be described in further detail, taken together with the drawings showing a single rotary shaft tool, in which:

FIG. 1 shows a schematic side view of a single rotary shaft tool,

FIG. 2 shows a cross section of the cutting head along the line II-II in FIG. 1.

FIG. 3 shows a schematic, enlarged sectional representation of the detail X in FIG. 1,

FIG. 4 shows an enlarged, schematic sectional representation of a cutter along the line IV-IV in FIG. 3.

FIG. 5a shows a schematic cross sectional representation of a produced chip, with a shaft tool that has a cutting edge angle of κ equal to 30°.

FIG. 5b shows a schematic cross sectional representation of a produced chip, with a shaft tool according to the invention that has a cutting edge angle of κ equal to 60°.

FIG. 5c shows a schematic cross sectional representation of a produced chip, with a shaft tool according to the invention that has a cutting edge angle of κ equal to 90°.

### DETAILED DESCRIPTION OF THE INVENTION

An object of the present invention is to provide a drill tool (reamer) that creates short breaking chips. The present invention describes a single rotary tool. The tool has at least one cutting edge. Each cutting edge has a back rake γ and a cutting edge angle κ that creates short breaking chips. The back rake γ is less than 0°. Selecting the back rake of the single rotary tool dictates the selection of the cutting edge angle. The cutting edge angle is adapted to the change in the back rake and vice versa. The angles are changed inversely relative to each other. In that sense, the cutting edge angle and the back rake are related to each other.

Creating short breaking chips also depends upon the feed per revolution and per cutting edge of the cutting tool, and the difference between the diameter of the cutting tool and the diameter of the borehole after the hole is machined by the cutting tool. For example, referring to FIGS. 5a-5c, if the diameter of single the cutting tool is d₁ and the diameter of the machined borehole is d₀ and the difference (d₀−d₁)=0.2 mm, and the tool has only one cutting edge, then the feed of the rotary cutting tool would be 0.2 mm per revolution. If the tool has two cutting edges, then the feed would be 0.4 mm per revolution. With a feed of the cutting tool in a range of about 0.1 mm per revolution and per cutting edge to about 0.3 mm per revolution and per cutting edge, a chip is produced whose width is about three times its thickness.

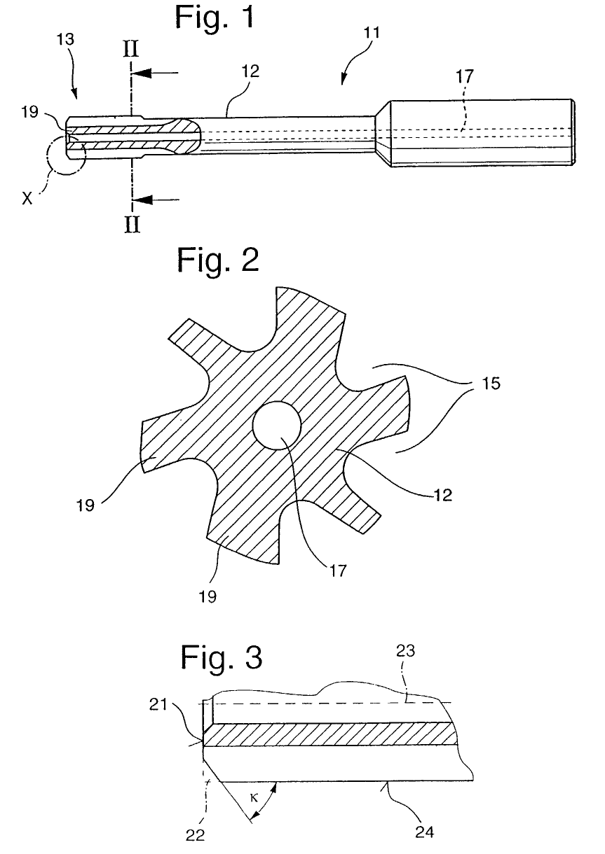

A rotary cutting tool 11 is shown in FIG. 1, and has a cylindrical shaft 12 and a cutter head 13 set in the cylindrical shaft 12. The cutter head 13 described herein below is produced as a molded body of a cutting material. Alternatively, a cutter head 13 can be provided which is made of a less expensive material on which inset cutter plates are provided. This embodiment is particularly advantageous for cutter heads 13 with an external diameter of, for example, 15-17 mm.

The cutter head 13 has chip grooves 15 that are adjoined by a chip outlet region 16 of the chip grooves 15. A coolant/lubricant channel 17 extends in the shaft 12, in order to conduct coolant, lubricant or cooling liquid into the borehole.

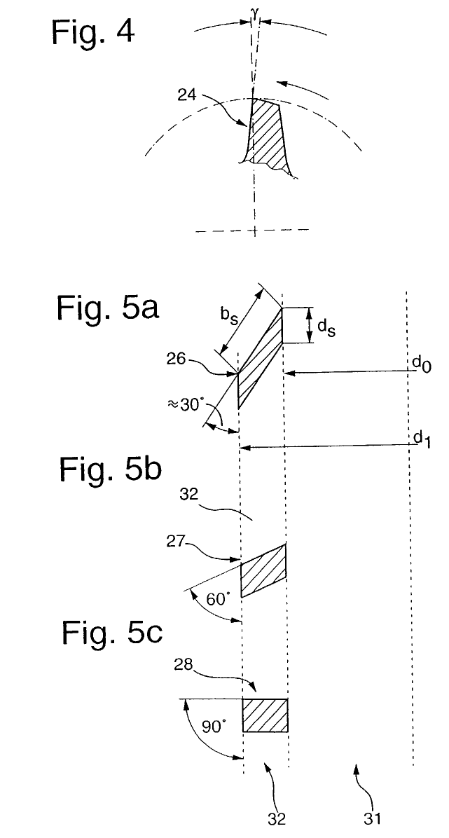

A section of the cutter head 13 along the line II-II in FIG. 1 is shown in FIG. 2. This cutter head 13 has, for example, cutting edges 19 that have lands made with different thicknesses, in order to make possible a smooth cutting behavior. The formation of the back rake angle γ is shown in FIG. 4 and will be described in more detail herein below.

An enlarged view of the detail X of FIG. 1 is shown in FIG. 3. The cutter head 13 has an end face 21 that faces into a borehole, preferably into a blind hole, and that is adjoined radially outward by a major cutting edge 22 that is arranged, for example, at a cutting edge angle of κ equal to 60° with respect to a longitudinal axis 23 of the shaft tool 11. The minor cutting edge 24 adjoins the major cutting edge 22. It is made long in comparison with the major cutting edge 22, and serves at the same time to guide the shaft tool 11 in the borehole.

The length of the major cutting edge 22 is such that, at least seen in a projection onto the borehole, it is larger than the dimensions of the borehole to be machined. The cutting edge angle κ is in the range between 45° and 90°. A cutting edge region of the major cutting edge 22, of κ equal to 90°, is shown with dashed lines as an example.

The back rake γ of the minor cutting edge 24 is determined depending on the cutting edge angle κ of the major cutting edge 22. Alternatively, the reverse can be the case.

The cutting edge angle κ and the back rake γ are selected for the respective cases of use, in order to be optimal for the properties of the material, the dimensions of the borehole, the number of cutting edges or teeth, and also the cutting parameters. For example, a cutting edge of a shaft tool (not shown) can have a cutting edge angle κ in a range of 0° to −45°, and the back rake can be made negative, the magnitude of the negative back rake being related to the feed, the number of cutting edges, and the further operating parameters such as the material of the cutter, the material to be machined, etc.

According to FIG. 4, the minor cutting edge 24 has a negative back rake γ, which is preferably in the range between 0° and −15°. A dragging cut can be achieved in this manner, and can influence the deformation behavior of the chip. The relationship of the cutting edge angle κ to the back rake γ, or their mutual dependence, is such that the larger the cutting edge angle is made, the smaller the magnitude of the back rake γ, and vice versa. It goes without saying that any optional variations in the preferred ranges of the cutting edge angle κ between 45° and 90° and the back rake angle γ between 0° and −20° can also be provided. Furthermore, it can likewise be provided that the cutting edge angle κ can be set to a given magnitude and the back rake γ per cutting edge can be made of different magnitude. Any optional variation between the cutting edge angle κ, the back rake γ, and the number of teeth, or in relation to the cutting edge angle κ and the back rake γ, is possible.

Cross sections of a produced chip are shown in FIGS. 5a-5c. The cross section of the chip 26 is produced by means of a rotary shaft tool that has, for example, a cutting edge angle of κ equal to 30° and a back rake of γ equal to −15°.

The cross sections 27 and 28 are likewise produced with the shaft tool 11 according to the invention. The shaft tool 11 for the production of the chip according to FIG. 5b has a cutting edge angle of κ equal to 60° and a back rake of γ equal to −8°, for example for machining steel. The cross section 28 of the chip in FIG. 5c was produced with a shaft tool 11 according to the process according to the invention, having a cutting edge angle of κ equal to 90° and a back rake of γ equal to −1.

These numerical data, set out as examples, are not limitative. On the contrary, an individual match to the material and to the working conditions and other peripheral conditions can be possible.

In FIGS. 5a-5c, a partial detail is shown of a blind hole 31 to be machined, having a diameter before machining of d₀ and a final measurement according to the diameter d₁ after fine machining. The difference between the radius R₀ of the diameter d₀ and the radius R₁ of the diameter d₁ forms the dimensions 32 of the borehole 31, which determines the chip width bₛ in dependence on the cutting edge angle κ. The chip thickness dₛ is determined by the feed of the shaft tool 11, for the fine machining of the blind hole 31, wherein according to the invention a feed in the range of 0.2-0.3 mm/revolution per tooth or cutting edge 19 is provided. Thus the chip thickness corresponds to the feed of 0.2-0.3 mm. The feed can of course also include the range of 0.1 to 0.5 mm per revolution and per tooth or per cutting edge. The term “tooth” and “cutting edge” have the same meaning. These data are dependent on the diameter of the tool, and are thus also dependent on the cutting edge used, so that smaller performance data can hold for smaller tools. This is related, in particular, to the fact that a smaller chip space is available at a smaller diameter, and sufficient chip removal has nevertheless to be insured.

It is advantageously provided that the dimensions 32 of the borehole 31 to be machined approximately relates to the feed per cutting edge, so that an about square cross section of the chip can be produced. It will be understood that it is also possible to depart from this relationship, a cross section being produced, however, which is substantially nearly square or like a rectangle.

In FIG. 5b, a cross section 27 is shown of a chip that is produced with a shaft tool 11 that was used as a high performance, multiple cutter, fine machining tool. Cutting speeds of, for example, between 100 m/min and 400 m/min, and a feed of 0.2-0.3 mm/revolution and per cutting edge 19 were employed for the production of a chip cross section of this kind. Other cutting speeds can apply. (As stated above, the feed can also include the range of 0 to 0.5 mm per revolution and per cutting edge). The cutting edge angle κ of the major cutting edge has an angle of 60°, so that an about rectangular cross section is formed.

In FIG. 5c, a nearly square cross section 28 is formed according to the process according to the invention with the shaft tool 11 according to the invention. The shaft tool 11 has a cutting edge angle of κ equal to 90°. The operating parameters for fine machining of the blind hole 31 substantially correspond to the operating parameters described relating to FIG. 5b.

The fine machining of blind holes 31 can be assisted by coolant/lubricant. Cooling liquid under pressure, preferably under high pressure, can be forwarded to the end face 21 of the shaft tool 11 via the coolant channel 17 that runs centrally in the shaft 12. The liquid is deflected at the bottom of the borehole and can be conducted out of the borehole 31 via the chip outlet region 16. A reverse scavenging of this kind facilitates removal of the chips that are broken off short. Alternatively, air can also be used as a coolant/lubricant.

The shaft tool 11 can be constructed as a multi-cutter friction tool or as a single-cutter friction tool and also as a tap. Further applications are also possible in which the parameters of cutting edge angle κ, back rake angle γ and feed of the shaft tool are matched to each other in order to produce a cross section of the chip that is short-breaking and that is of rectangular shape, nearly square, and/or substantially square.

1. A process for high performance fine machining of boreholes comprising: employing a rotary shaft tool having a shaft with at least one longitudinal channel for coolant and lubricant, and a cutting head that has at least one cutting edge, a chip groove and a minor cutting edge with a back rake (γ) of less than 0°, wherein the relationship of said back rake (γ) to said cutting edge angle (κ) of said rotary shaft tool is such that the smaller the back rake (γ) the larger the cutting edge angle (κ), and
machining a borehole with feed per revolution and per cutting edge of said rotary shaft tool that depends upon the diameter of said rotary shaft tool and the diameter of said borehole.

2. The process according to claim 1, further comprising employing a major cutting edge with a cutting angle (κ) of greater than 45°.

3. The process according to claim 1, further comprising advancing said rotary shaft tool with a feed of about 0.1-0.4 mm per revolution and per cutting edge of said rotary shaft tool.

4. The process according to claim 1, further comprising driving said rotary shaft tool at a cutting speed of about 100-400 m/min.

5. The process according to claim 1, further comprising fine-machining a blind hole.

6. The process according to claim 1, further comprising conducting coolant through said longitudinal channel and transporting away chips by reverse scavenging.

7. The process according to claim 1, further comprising dry fine machining a blind hole.

8. A rotary shaft tool, comprising:
a shaft having at least one longitudinal channel for coolant and lubricant,
a cutter head joined to said shaft and having at least one cutting edge at an angle (κ) with
respect to a longitudinal axis of said rotary tool shaft,
a minor cutting edge having a back rake (γ), and a chip groove,
wherein said cutting edge angle (κ) is at least about 45°, and
wherein said back rake (γ) is between about less than 0° and about −20°, and
wherein the relationship of said back rake (γ) to said cutting edge angle (κ) of said rotary shaft tool is such that the smaller the back rake (γ) the larger the cutting edge angle (κ).

9. The shaft tool according to claim 8, in which said back rake (γ) decreases as said cutting edge angle (κ) increases.

10. The shaft tool according to claim 8, in which said cutting edge angle (κ) is greater than about 45°.

11. The shaft tool according to claim 8, in which said cutting edge angle (κ) is between about 45° and about 90°.

12. The shaft tool according to claim 8, in which said back rake angle (γ) is between about 0° and about −20°.

13. The shaft tool according to claim 8, in which said cutting edge angle (κ) and said back rake (γ) are dimensioned with respect to each other, so that with a feed of said shaft tool in a range of about 0.1 mm per revolution and per cutting edge to about 0.3 mm per revolution and per cutting edge a chip is produced whose width is about three times its thickness.

14. The shaft tool according to claim 8, in which said cutting edge angle (κ) and said back rake (γ) are dimensioned with respect to each other, so that with a feed of said shaft tool in a range of about 0.1 mm per revolution and per cutting edge to about 0.3 mm per revolution and per cutting edge, a chip having a nearly square cross section is produced.
